(19) United States
(12) Patent Application Publication
(10) Pub. No.: US 2025/0027763 A1
(43) Pub. Date: Jan. 23, 2025

(54) OPTOELECTRONIC DEVICE, SELF-MIXING INTERFEROMETER AND METHOD FOR OPERATING A SELF-MIXING INTERFEROMETER

(71) Applicant: ams International AG, Jona (CH)

(72) Inventor: Matthias STEINER, Seiersberg (AT)

(21) Appl. No.: 18/713,195

(22) PCT Filed: Oct. 7, 2022
(86) PCT No.: PCT/EP2022/077886

§ 371 Date: May 24, 2024

(30) Foreign Application Priority Data
Dec. 8, 2021 (DE) 10 2021 213 961.2

(51) Int. Cl. G01B 9/02; G01B 9/02002; G01B 9/02055; G01S 7/4912; H04R 1/04; H04R 23/00

(52) U.S. Cl. CPC G01B 9/02092; G01B 9/02005; G01B 9/02069; G01B 9/02078; G01S 7/4916; H04R 1/04; H04R 23/008

(57) ABSTRACT

An optoelectronic device for a self-mixing interferometer includes a driver block, a semiconductor laser (SCL), a detector (DTC) and a switching network (SWN). The driver block is operable to provide a time modulated control signal, wherein the control signal has a periodic waveform. The semiconductor laser (SCL) is operable to emit a laser light with a time-dependent characteristics being a function of the control signal and a self-mixing interference optical feedback. The detector (DTC) is operable to generate a detection signal depending on the time-dependent characteristics. The switching network (SWN) is arranged to provide a time sequence of detection signals per period of the control signal.

### RELATED APPLICATION(S)

This application is a US National Stage Application of International Application PCT/EP2022/077886, filed on 7 Oct. 2022, and claims priority under 35 U.S.C. § 119(a) and 35 U.S.C. § 365(b) from German Patent Application DE 10 2021 213 961.2, filed on 8 Dec. 2021, the contents of which are incorporated herein by reference in their entirety.

### FIELD

The present disclosure relates to an optoelectronic device for a displacement sensor for self-mixing interferometer, to a self-mixing interferometer and to a method for operating a self-mixing interferometer. One aspect of the present disclosure relates to an optical microphone.

### BACKGROUND

Optical sensors are commonplace in a large variety of today's electronic devices such as mobile devices, cell phones, tablet or laptop computers, watches, and so on, but also non-mobile devices, such as desktop computers, and so on. Optical sensors can be designed as displacement sensors, optical microphones, optical devices for distance and/or speed measurements, refraction index measurements and the like. For example, optical microphones can be manufactured with optical readout. These devices often are demanded to meet the constraints for consumer product microphones, such as small size with short external cavity length, simple optical path construction, and bandwidth high enough to cover 20 kHz audio, artifact- and interruption-free operation.

In the art optical sensors have been suggested based on self-mixing interference (SMI for short). A laser beam emitted by a semiconductor laser, such as a vertical-cavity surface-emitting laser, or VCSEL, is directed onto a reflective surface (or target) which moves with the applied sound pressure (see FIG. 8A). The reflected laser is fed back into the laser, which causes the optical field to influence the operation of the laser by light interference. Since the reflected light experiences a varying phase shift depending on the surface position, the overall light intensity is varying (see FIG. 8B). The light intensity can be captured by either sensing the light intensity with a dedicated photodetector (i.e., reading out the power) or by sensing the laser voltage/current characteristic (e.g., via its voltage readout). A phase shift of reflected light at target distance d results as:

$${φ}_{0} = 2 π \cdot \frac{2 d}{λ} ,$$

with λ being the laser light emission wavelength. In other words, the phase shift also depends on the wavelength λ emitted by the laser.

However, the readout signal (either power or voltage/current) does not have a direct monotonic or linear relationship to the original surface position, but rather follows a periodic function which repeats for each surface travel of half a light wavelength (λ/2, e.g., 440 nm at laser 880 nm light) (see FIG. 8B). Consider an optical sensor arranged as an optical microphone. In order for the optical microphone to achieve a high AOP, short for acoustic overload point, which is the loudest audio signal the microphone can handle without excessive signal distortion, it may be necessary that the readout mechanism is able to process multiple such periods to reconstruct the original audio signal from it with low distortion.

The art has come up with several attempts to overcome this problem. One readout technique contains a regulation loop which is open in the signal band of interest. A photodiode current I_{PD} can be directly converted to the output voltage Vₒᵤₜ with a transimpedance amplifier, which represents the displacement d. For this to work, the circuit needs to operate in a phase range with reasonably linear relationship between displacement d and I_{PD}, which seriously limits a maximum range. Another readout technique employs a closed loop. A “DC like” (i.e. slow changing) target value is subtracted from the signal representing the photodiode current I_{PD}, and the residue is amplified by a large gain to define a VCSEL drive current. This loop is acting as a closed regulation loop, and is intended to keep the SMI phase constant at a target value (“phase nulling”). Compared to the open loop technique, this potentially widens the usable displacement range. However, a slow target phase regulation is required to pick out a target phase that is on a steep position of the SMI characteristic to keep the phase nulling regulation loop operational even if the SMI assembly properties are drifting with temperature.

While the art addressed the readout with various loop architectures, these solutions seriously limit a maximum range. Some optical sensors like optical microphones, however, rely on large usable displacement ranges in order to accurately reconstruct a surface movement, e.g. as a sound signal.

Various embodiments of the present disclosure relate to optoelectronic device for a displacement sensor for self-mixing interferometer, a self-mixing interferometer and a method for operating a self-mixing interferometer with improved properties, including larger detection range, and reduced complexity.

It is to be understood that any feature described in relation to any one embodiment may be used alone, or in combination with other features described herein, and may also be used in combination with one or more features of any other of the embodiments, or any combination of any other of the embodiments unless described as an alternative. Furthermore, equivalents and modifications not described below may also be employed without departing from the scope of the optoelectronic device, self-mixing interferometer and method for operating a self-mixing interferometer which are defined in the accompanying claims.

### SUMMARY

The following relates to an improved concept in the field of optical sensors, such as optical microphones. The improved concept employs a “phase scanning” technique which is using a semiconductor laser as a tuning element. The scanned multiple phase values are then used to compute a position of a target or surface, such as a membrane. These computed positions can be used to reconstruct a sound signal, for example.

In at least one embodiment an optoelectronic device for a self-mixing interferometer comprises a driver block, a semiconductor laser, a detector and a switching network. The driver block is operable to provide a time modulated control signal, wherein the control signal has a periodic waveform. The semiconductor laser is operable to emit a laser light with a time-dependent characteristics being a function of the control signal and a self-mixing interference optical feedback. The detector is operable to generate a detection signal depending on the time-dependent characteristics. The switching network is arranged to provide a time sequence of detection signals per period of the control signal.

The time modulated control signal follows a periodic function of time. For example, the control signal is a driving current of the semiconductor laser. Time modulation may be achieved in a non-continuous manner. The control signal may alter internal properties of the semiconductor laser such that emission, e.g. emission wavelength and/or power output, is affected in a time dependent manner as well. Thus, time-dependent characteristics is altered. Furthermore, if the optoelectronic device is used in a self-mixing interferometer an optical feedback, e.g. by means of reflected light entering into the laser cavity, may alter the time-dependent characteristics as well. In the absence of an optical field induced by SMI, there may be no change to the time-dependent characteristics but the time modulated control signal.

The proposed concept can have various advantages. The optoelectronic device enables the processing of membrane movements beyond λ/2 (i.e., multiple interference periods), when used in a self-mixing interferometer with a membrane. The achievable AOP is not restricted by the wavelength tuning range of the semiconductor laser, which becomes a limiting factor for short external cavity lengths. A fine target position resolution may well be below one entire SMI fringe.

Compared to prior art solutions there is no regulation loop around the SMI construction, but a constant periodic stimulus (“scan”). This alleviates speed constraints that would arise from regulation loop stability, and keeps the power consumption constant from the periodic steady-state. In fact, the light phase from the membrane idle position can be arbitrary, and does not have to be trimmed or regulated to a specific phase. It is allowed to vary over process variations, or drift over temperature, making it robust for mass production. A slow response from the semiconductor laser can be tolerated, because after characterization it can be taken into account when computing the SMI phase from the individual multiple phase results. The driving and signal sensing of the semiconductor laser can continuously be used for measuring a displacement (e.g., for audio), i.e. it does not need to be interrupted to perform calibration operations (e.g. for “phase locking”) that consume power but do not give any direct contribution to the measurement result. This may improve the power efficiency. These advantages come with larger detection range and reduced hardware complexity.

In at least one embodiment the optoelectronic device for a self-mixing interferometer comprises a common integrated circuit. The common integrated circuit comprises at least the driver block, detector and switching network. Further, components may be integrated into the common integrated circuit as well, so that the optoelectronic device may be considered an all integrated device. However, the semiconductor laser may not be comprised by the common integrated circuit but rather be electrically connected and/or attached to the common integrated circuit. This way, the semiconductor laser may be manufactured using a different technology then the common integrated circuit. For example, the common integrated circuit may be manufactured from a CMOS process, while the semiconductor laser may be based on GaAs technology.

In at least one embodiment the detector comprises a photodetector and/or a voltage meter and/or a current meter. The photodetector is operable to provide the detection signal as an optical power readout. The voltage meter is operable to provide the detection signal as a voltage readout. The current meter is operable to provide the detection signal as a current readout. The proposed concept herein applies to different sensor readout, e.g. power readout, current and voltage readout so that the detector may be implemented as a photodetector and/or voltage/current meter, for example.

In at least one embodiment the switching network is configured to assume a sequence of switching states. In each switching state the switching network provides a detection signal from the time sequence of detection signals.

The detection signal is a measure of the time-dependent characteristics of the semiconductor laser, which, ultimately, is determined by the control signal and the optical feedback of self-mixing interference, if present. Thus, the detection signal may change as a function of time as well. In a certain sense, the switching network scans the detection signal by means of the sequence of switching states. The sequence may finish within the same period as the control signal. The temporal sequence of switching states may determine a time resolution of the detection signal. Detection signal may be acquired as detection values, analog or digital, from temporal sequence of switching states and be associated to a corresponding time. Temporal changes of the detection signal may thus be apparent from the detection values.

In at least one embodiment the driver block comprises a stimulus generator and a driver circuit. The stimulus generator is operable to generate a periodic stimulus waveform as a function of time. The driver circuit is arranged to receive the stimulus waveform and is operable to generate the control signal depending on the received stimulus waveform.

The periodic stimulus waveform can be considered the function which determines the modulation of the control signal. For example, the stimulus waveform may be a non-continuous function of time. The stimulus waveform may be a sectional function comprised of sections of step-functions and/or linear functions, which repeat periodically. A section may be associated with a certain time or time stamp. The driver circuit may be an electronic component, such as an amplifier, which generates the control signal, e.g. a driving current or voltage.

In at least one embodiment the optoelectronic device further comprises a clock generator. The clock generator is operable to provide a clock signal. The driver circuit is operable to provide the time modulated control signal synchronous with the clock signal. The sequence of switching states is synchronized with the clock signal. This way, time modulated control signal and time sequence of switching states is synchronized.

In at least one embodiment the stimulus generator is synchronized with the clock signal so that the time dependence of the stimulus waveform is determined by the clock signal.

In more detail, synchronization may be implemented using the stimulus generator. When synchronized to the clock signal for a given time the stimulus waveform holds the values defined by the sections of the function that form the stimulus waveform, respectively. The stimulus waveform is fed into the driver circuit, which, in turn, produces a time modulated control signal, or periodic IVCSEL waveform, having a synchronous temporal behavior. The control signal may be a bias or driving current for the semiconductor laser, for example. In turn, the detection signal has a synchronous temporal behavior as well. This way control signal and detection can easily be associated with one another, i.e. a given control signal (e.g., driving current) can uniquely be associated with a detection value, acquired by means of the switching network.

In at least one embodiment the driver circuit comprises an amplifier which is operable to generate the time modulated control signal as a driving current for the semiconductor laser.

In at least one embodiment the optoelectronic device further comprises an analog-to-digital converter. In one option, the analog-to-digital converter is coupled between the detector and the switching network. The analog-to-digital converter is operable to receive the detection signal and provide the detection signal in digital form to the switching network. In another option, the analog-to-digital converter is coupled to output terminals of the switching network and comprises time-interleaved ADC-channels. Each channel may be associated with a corresponding output terminal of the switching network. The analog-to-digital converter may convert the detection signal into digital detection values. The digital form may reduce complexity of signal processing.

In at least one embodiment the optoelectronic device further comprises a computation unit. The computation unit is operable to acquire detection values from the time sequence of detection signals and calculate an output are indicative of a target distance to be placed in a field of view of the semiconductor laser. For example, in a self-mixing interferometer the optoelectronic device may be place in front of a movable membrane. The time-dependent characteristics being a function of the control signal and a self-mixing interference by way of optical feedback from laser light reflected at the membrane. The acquired detection values from the time sequence of detection signals may be modulated by a varying distance of the membrane, so that the calculated output is a measure of the varying target distance.

In at least one embodiment the computation unit comprises a target phase computation unit and/or a phase unwrapping unit. The target phase computation is operable to determine the output from the time sequence of detection signals and corresponding control signal. The phase unwrapping unit is operable to remove a phase discontinuity from the calculated output.

In at least one embodiment a self-mixing interferometer, comprises an optoelectronic device according to one or more of the aspects discussed herein. A reflective membrane is placed with respect to the semiconductor laser so as to form the self-mixing interferometer.

In at least one embodiment the driver block, semiconductor laser, detector and/or switching network are integrated into a common integrated circuit.

The semiconductor laser, which may be a VCSEL, may not be integrated into the integrated circuit, because the integrated circuit (e.g., comprising the detector, the driver block, or further components such as a signal processing block, like target phase computation unit and phase unwrapping unit) may be manufactured in a silicon CMOS process, whereas the semiconductor laser may have a gallium arsenide (GaAs) base. In such case, the semiconductor laser can be attached to a surface of the common integrated circuit (or silicon) and connected via gluing pads or bonding pads.

In at least one embodiment the self-mixing interferometer is arranged as an optical microphone and operable to provide a sound signal as output.

In at least one embodiment a method for operating a self-mixing interferometer, comprising the step of providing a time modulated control signal, wherein the control signal has a periodic waveform. A laser light is emitted towards a target, the laser light having a time-dependent characteristics being a function of the control signal and a self-mixing interference optical feedback. A detection signal is generated and is indicative of a self-mixing interference depending on laser light reflected back from the target and depending on the time-dependent characteristics. Finally, a time sequence of detection signals is provided per period of the control signal.

In at least one embodiment a distance to the target is calculated from the time sequence of detection signals and the corresponding control signal, and/or the distance is calculated as a function of time to derive a sound signal.

Further advantages and embodiments as well as further developments of the presented description result from the embodiments described below in connection with figures.

### BRIEF DESCRIPTION OF THE DRAWINGS

In the embodiments and figures, identical or similarly acting components may each be provided with the same reference signs. The elements shown and their size ratios with respect to one another are not to be regarded in principle as true to scale; rather, individual elements, such as layers, components, structural elements and areas, may be shown in exaggeratedly thick or large dimensions for better representability and/or for better understanding.

FIG. 1 shows an example embodiment of a self-mixing interferometer with an optoelectronic device,

FIG. 2 shows an example illustration of a time-dependent characteristics of the semiconductor laser,

FIG. 3 shows an example of a time modulated control signal,

FIG. 4 shows an example detection signal,

FIG. 5 shows another example detection signal,

FIG. 6 shows another example detection signal,

FIG. 7 shows a periodic detection signal as a function of distance and respective stimulus phase φ₀,

FIG. 8A shows an example embodiment of a self-mixing interferometer from the prior art, and

FIG. 8B shows a periodic SMI readout signal depending on the target position.

### DETAILED DESCRIPTION

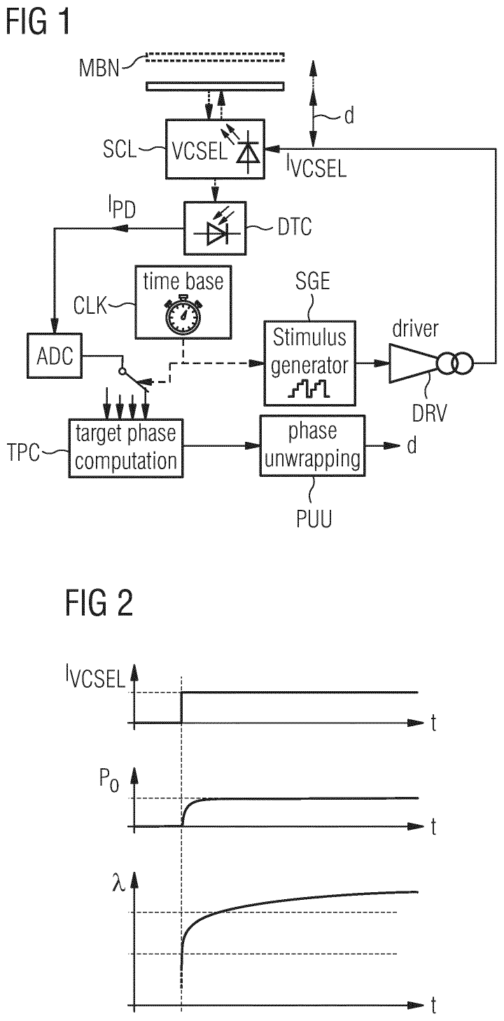

FIG. 1 shows an example embodiment of a self-mixing interferometer with an optoelectronic device. The optoelectronic device comprises a driver block, a switching network SWN, as well as a detector DTC and a semiconductor laser SCL. For example, the optoelectronic device is implemented as an integrated circuit with its components integrated into a common substrate. However, in other embodiments at least parts of the optoelectronic device can be implemented as individual components, e.g. externally to a common integrated circuit. For example, the semiconductor laser can be a separate component of the optoelectronic device. In such case the semiconductor laser can be mounted or otherwise be electrically connected to the common integrated circuit, for example.

The semiconductor laser SCL is positioned with respect to a reflective membrane MBN. Together the semiconductor laser and membrane form a self-mixing interferometer in which a laser beam emitted by the laser may be reflected from the membrane, back into the semiconductor laser. In this embodiment the semiconductor laser comprises a vertical-cavity surface-emitting laser, or VCSEL. Other lasers may be implemented, including edge-emitting laser diodes, external cavity diode lasers, optically pumped surface-emitting external-cavity semiconductor lasers (VECSELs) or Photonic crystal surface emitting laser diodes (PCSEL) to name but a few. With VCSELs, the lasing cavity is directed vertically with respect to the fabrication wafer. VCSELs can be mounted on a substrate so that the emitted laser light can be directed toward the membrane. In general, any semiconductor laser can be used which may be set up in a self-mixing interferometry setup. Some conventional lasers or edge-emitting laser diodes may also be able to receive laser light back into their laser cavity and undergo self-mixing.

The driver block comprises a stimulus generator SGE and a driver circuit DRV further comprising an amplifier. An output of the driver circuit is coupled to the semiconductor laser. The stimulus generator is coupled to an input of the driver circuit.

The detector DTC comprises a photodetector, e.g. a photodiode. The detector is arranged with respect to the semiconductor laser SCL so that laser light emitted by the laser may be collected by the detector. An output of the detector is connected to an analog-to-digital converter ADC. An output of the analog-to-digital converter is connected to an input side of the switching network SWN.

The switching network SWN may be implemented as a demultiplexer. For example, the switching network comprises a single input terminal, which is connected to the output of the analog-to-digital converter ADC. Furthermore, the switching network comprises a plurality of output terminals. The input terminal is electrically connected to any one of the output terminals only in a defined switching state. The number of output terminals may be different depending on the desired application. For example, the number can be chosen to meet a desired accuracy for signal acquisition, as will be apparent from the discussion further below.

The optoelectronic device further comprises a clock generator CLK. The clock generator is coupled to both the driver block (by means of the stimulus generator) and to the switching network.

The output terminals are coupled to a signal processing block. The signal processing block comprises a target phase computation unit TPC. The target phase computation unit is further connected to a phase unwrapping unit PUU. These two units may be implemented as one or more microcontrollers or microprocessors, such as a digital signal processor (DSP), or as parts thereof, for example. However, these two units may also be electronic components on their own, e.g. based on logic or digital circuitry. The phase unwrapping unit comprises an output to provide a measurement signal which is indicative of a distance between the semiconductor laser and the membrane. Furthermore, the two units may be implemented on the common integrated circuit mentioned above, for example forming an ASIC. However, signal processing may also be performed entirely, or in parts, by using external components as target phase computation unit and/or phase unwrapping unit.

Operation of the self-mixing interferometer is based on self-mixing interference (denoted SMI hereinafter). For the sake of illustration of the improved concept the following assumes that the self-mixing interferometer is designed as an optical microphone with optical readout. However, in general the concept discussed below can be applied to other applications, such as displacement sensors, and optical devices for distance and/or speed measurements, refraction index measurements and the like.

The semiconductor laser SCL, e.g. VCSEL, emits a laser beam of light which is directed onto the reflective membrane MBN as target placed in a variable distance d. In the application as optical microphone, the membrane eventually moves with the applied sound pressure. Reflections of the emitted light can be received back into the lasing cavity to create self-mixing interference. In the laser cavity interference occurs between the internal optical field and the returned laser beam, backscattered or reflected by the membrane. The semiconductor laser and the membrane form a self-mixing interferometer.

The applied sound pressure induces variations of an optical path length or a varying phase shift depending on the membrane position. As a consequence, the overall light intensity also varies due to the varying phase shift. For example, the optical power of the semiconductor laser is a modulated waveform, forming part of a time-dependent characteristics of the laser. This modulated waveform can be captured by either sensing the light intensity with the dedicated photodetector (power readout, this example embodiment) or by sensing the laser voltage/current characteristic (voltage/current readout).

Self-mixing interference may alter performance properties or parameters of the semiconductor laser SCL or its emitted coherent light in ways that can be detected. These changes are denoted a time-dependent characteristics in the following. The time-dependent characteristics include changes in a junction voltage, a bias current, a supply voltage, or a power output, for example. Further, self-mixing interference is dependent on the distance between the membrane MBN and the lasing cavity, such that the distance may be correlated to a detection signal (e.g., I_{PD}) generated by the detector DTC.

The optoelectronic device can be operated using a time multiplexed (or scanning) SMI readout technique. The stimulus generator SGE generates a periodic stimulus waveform. The stimulus waveform may be a non-continuous function of time, for example. The stimulus waveform may be a sectional function comprised of sections of step-functions and/or linear functions, which repeat periodically. The stimulus generator may be synchronized to a clock signal generated by the clock generator CLK, so that for a given time the stimulus waveform holds the values defined by the sections of the function that form the stimulus waveform, respectively. The stimulus waveform is fed into the driver circuit DRV, which, in turn, produces a time modulated control signal, e.g. a periodic I_{VCSEL} waveform. The control signal may be a bias or driving current for the semiconductor laser, for example.

The time-dependent characteristics of the semiconductor laser operation may thus be determined by the control signal. One parameter of the time-dependent characteristics is emission wavelength λ, which shifts as a function of the control signal, e.g. the bias current. Thus, the control signal converts into a defined sequence or evolution of laser wavelengths λ. As a consequence, a SMI phase φ_{FB} of the target position d is shifted by different offset phase values over time, repeated within each period of the stimulus waveform, or of the control signal.

The different offset phase values over time can be detected by the detector DTC. In this embodiment the photodetector generates a photocurrent I_{PD} as detection signal. The photocurrent changes as a function of time, having the same time base as the clock signal. In order to acquire this time dependence of the detection signal, the detection signal is continuously converted from analog to digital using the analog-to-digital converter ADC. The digital values (or detection values) are then provided to the switching network SWN, e.g. a demultiplexer. The switching network assumes a sequence of switching states, which results in a time sequence of detection signals per period of the control signal, having the same time base as the clock signal. The switching states change synchronously with the clock signal, which is also synchronous with the time modulated control signal.

In this embodiment the resulting detection signal, or I_{PD} current wave, is de-multiplexed with corresponding timing, yields a set of digital detection values that represent the shifted multiple SMI phases (for example four). In other words, the optoelectronic device effectively scans through a range of phases around the target position's SMI phase. A repetition rate of the stimulus generator SGE therefore defines the sampling rate of the membrane position, which influences also the time sequence of detection signals per period of the control signal. For an optical microphone the repetition rate should be well above 40 kHz to capture the whole audio band and to reduce aliasing.

The extracted digital detection values are then used to compute the SMI phase value which corresponds to the target (or membrane) position, denoted d. For example, if the target position is constant, the scanned multiple phase values are staying constant from one scan period to the next, and the extraction would yield a repeated constant reconstructed position result. Signal processing is performed in the computation unit, e.g. the target phase computation TPC and/or phase unwrapping unit PUU. Details of the processing will be discussed further below.

The involved phase computation is complex, which is why I_{PD} is digitized with an ADC for digital processing. The ADC has a current input to collect the detection signal, i.e. photodiode current charge, directly, there is no TIA in front of it. In an alternative embodiment, the switching network could be placed in front of a set of time-interleaved ADC channels rather than at the digital output.

Notice the absence of an SMI phase regulation loop like in several prior art techniques. The interferometer is “free running” with a periodic stimulus waveform independent of the current membrane position, and the membrane position is calculated from whatever set of values is created by this independent stimulus. Note that the calculation may still need to know the stimulus waveform in order to compensate the induced intensity variation, for extraction of the SMI signal with the phase information. The wavelength variation may be chosen to cover a phase shift of one entire interference phase period, but can be extended to e.g. two periods to extract gain information from the driver-VCSEL-detector chain.

FIG. 2 shows an example illustration of a time-dependent characteristics of the semiconductor laser. The stimulus waveform can be chosen to fit the needs of stimulus generator complexity and dynamic response of the SMI interferometer. The drawing shows three graphs all being a function of time t. The uppermost graph shows an example of a simple time modulated control signal, which is a bias current I_{VCSEL} in this example. For example, the function is a simple step-function, and may be considered a section of the control signal. Such a two level waveform (e.g. simple step-function or just on/off) can provide a simple stimulus which still makes the emission wavelength k sweep through a wide range of wavelengths because of the slow laser wavelength response. This is apparent from the graph in the middle and more pronounced from the graph on the bottom shows.

The graph in the middle shows the non-SMI optical power P₀ of the semiconductor laser. The graph on the bottom shows resulting emission wavelength of the semiconductor laser as a function of time. It is apparent that as the I_{VCSEL} changes a dynamic response is introduced to both optical power P₀ and emission wavelength of the semiconductor laser. However, the non-SMI optical power follows fast, while the wavelength of the emitted light follows more slowly.

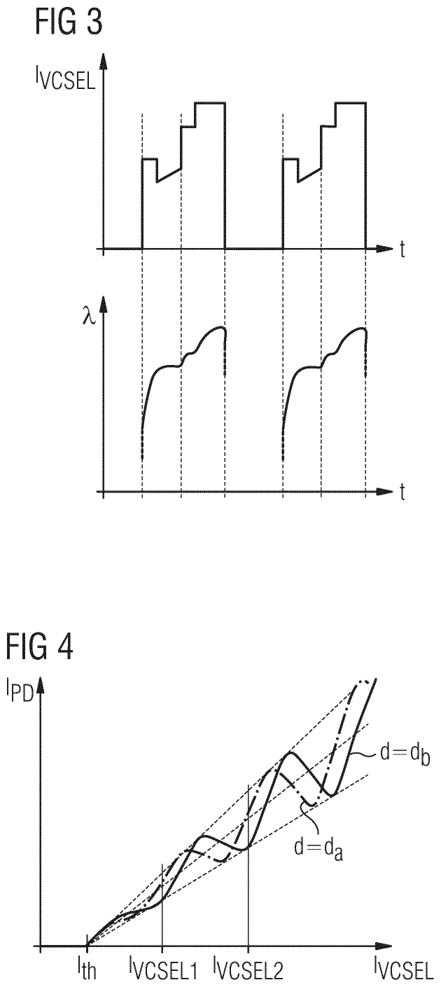

FIG. 3 shows an example of a time modulated control signal. This upper graph depicts a more complex time modulated control signal, i.e. a periodic I_{VCSEL} waveform, which is designed to induce a desired wavelength pattern given the slow and non-linear VCSEL response. The graph on the bottom shows the response of the semiconductor laser. A laser emission wavelength variation may be chosen to cover a phase shift of one entire interference phase period, but can be extended to e.g. two or more periods in order to extract gain information to characterize the chain comprising the driver block, semiconductor laser, and detector.

FIG. 4 shows an example detection signal. The depicted graph illustrates a sketch of a response function of a photodiode current I_{PD} (detection signal) to a change in VCSEL driving current I_{VCSEL} (control signal), for two different example target (membrane) positions d of dₐ and d_{b}. The sketch may give further background operation of the target phase computation unit.

The response follows a function

$${P}_{PD} = {P}_{0} \cdot [ 1 + m cos ( {φ}_{FB} ) ] ,$$

where P_{PD} is the total optical power from the semiconductor laser received by the detector, i.e. photodiode. The photocurrent I_{PD} is proportional to P_{PD} and is given by I_{PD} σ·P_{PD}, with σ the photodiode sensitivity. The term P₀ denotes the optical power at the detector (photodiode) if there was no interference from self-mixing (increases linearly with rising I_{VCSEL} above the semiconductor laser lasing threshold current Iₜₕ. The P₀ can be expressed as P₀=η·(I_{VCSEL}−Iₜₕ), with η the laser's slope efficiency towards the photodiode, m the modulation rate (strength) or the SMI effect, and φ_{FB} is the SMI phase.

The SMI phase φ_{FB} depends on the stimulus phase φ₀ via a non-linear relationship (called “excess phase equation”). The stimulus phase φ₀ is defined by the target (membrane) position d, and, importantly, also by the laser wavelength λ emitted by the semiconductor laser

$${φ}_{0} = 2 π \cdot \frac{2 d}{λ} ,$$

which in turn is tuned by I_{VCSEL}. This means that, next to the target position d, the SMI phase F_{B} is influenced by the driving current I_{VCSEL} (control signal), which allows capturing not just a single phase point on the characteristic for one given target position, but multiple φ_{FB} in the time-sequence of detection signals (“scanning”) conducted by means of the switching network.

The switching network assumes a sequence of switching states under control of the clock signal. In each switching state the switching network provides a detection signal from the time sequence of detection signals. In a certain sense the switching network scans through the response function by changing its switching states synchronously with the clock signal. At the same time the control signal is also synchronous with the clock signal. The detection signal may change as a function of the control signal (here driving current I_{VCSEL}) while the switching network changes from one switching state to another. This way the switching network provides a time sequence of detection signals (here photocurrent I_{PD}) per period of the control signal. For example, I_{VCSEL} can be varied between I_{VCSEL1} and I_{VCSEL2} to get multiple data points for reconstructing the target position rather than just one single phase point.

In this tuning method the laser wavelength k may not be the only term that influences the detection signal. The optoelectronic device may be operated in a regime where the optical power at the detector P₀ may have an effect on the detection signal. This may render the tuning relationship between driving current I_{VCSEL} and detection signal non-linear and frequency dependent. Although this complicates the extraction of the displacement, it still allows to keep the optical hardware simple. The complexity shifts to the target phase computation block.

The proposed SMI interferometer can be used as an optical microphone. Depending on the strength of the SMI feedback level C, the obtained SMI phase result is a more (high C) or less (low C) distorted version of the original stimulus phase of the membrane. For a given microphone construction the characteristic of this distortion is typically known (given C), so that a compensation can be added to the target phase computation if needed.

The proposed SMI interferometer may be applied for vibrometers or other ranging applications that require fast (>>1 kHz) conversion, sub-nanometer resolution and multiple wavelength period maximum signal, particularly if the length of the external cavity (distance to target) is well known.

The concept herein applies to both power readout, current and voltage readout so that the detector may be implemented as a photodetector and/or voltage meter, for example. The calculation are conducted in the target phase computation unit TPC.

FIG. 5 shows another example detection signal. The depicted graph illustrates a sketch of a response function of a photodiode current I_{PD} (detection signal) to a change in VCSEL driving current I_{VCSEL} (control signal), for two different example target (or membrane) positions d of dₐ and d_{b}. Different ways of signal processing can be applied depending on the stimulus waveform provided by the stimulus generator. Ultimately, either the target phase computation unit and/or the phase unwrapping unit output, as a result of signal processing, determine a measurement signal which is indicative of a distance between the semiconductor laser and the membrane.

Consider a stimulus waveform with four time sections at time stamps tₐ, t_{b}, t_{c}, and t_{d}. At these times, set in reference to the clock signal, the control signal has defined values I_{VCSELa}, I_{VCSELb}, I_{VCSELc}, and I_{VCSELd}, respectively. For the illustration purpose the control signal is considered to be a driving current of the semiconductor laser. The sections of the stimulus waveform may be chosen to yield a wavelength modulation (as a function of I_{VCSEL}) such that the shifted SMI phase can be captured four times, namely at 0, π/2, π and 3π/2 phase shift within each period, as indicated in the drawing. This is achieved by means of the switching network changing its switching state at time stamps tₐ, t_{b}, t_{c}, and t_{d}, under control of the clock signal. This scan, or sequence of switching states, yields four I_{PD} readout values, which are digital values in this example, denoted I_{PDb}, I_{PDb}, I_{PDc}, and I_{PDd}, respectively.

From these four I_{PD} readout values, I and Q components of the SMI phase can be extracted, provided that the SMI phase response φ_{FB} to the stimulus phase φ₀ from a membrane displacement or wavelength modulation is reasonably undistorted, i.e. P_{FB}≈φ₀ (true for small SMI feedback levels C). The SMI phase and thus the displacement can then be computed from

$${φ}_{FB} = {tan}^{- 1} ( \frac{Q}{I} ) .$$

The I and Q components can be extracted as follows.

The SMI response to I_{VCSEL} is described by

$${I}_{PD} = σ \cdot η \cdot ( {I}_{VCSEL} - {I}_{th} ) \cdot [ 1 + m cos ( {φ}_{0} ) ]$$

(assuming φ_{FB}=φ₀ from a small SMI feedback level C). The four capturing cases I_{PDb}, I_{PDb}, I_{PDc}, and I_{PDd} give the following relationships:

$${I}_{PDa} = σ \cdot η \cdot ( {I}_{VCSELa} - {I}_{th} ) \cdot [ 1 + m cos ( {φ}_{0} + 0 ) ]$$

$${I}_{PDb} = σ \cdot η \cdot ( {I}_{VCSELb} - {I}_{th} ) \cdot [ 1 + m cos ( {φ}_{0} + \frac{π}{2} ) ]$$

$${I}_{PDc} = σ \cdot η \cdot ( {I}_{VCSELc} - {I}_{th} ) \cdot [ 1 + m cos ( {φ}_{0} + π ) ]$$

$${I}_{PDd} = σ \cdot η \cdot ( {I}_{VCSELd} - {I}_{th} ) \cdot [ 1 + m cos ( {φ}_{0} + \frac{3 π}{2} ) ]$$

Using cos(a+b)=cos a cos b−sin a sin b allows to get separate sin( ) and cos( ) terms of φ₀:

$${I}_{PDa} = σ \cdot η \cdot ( {I}_{VCSELa} - {I}_{th} ) \cdot [ 1 + m cos {φ}_{0} ]$$

$${I}_{PDb} = σ \cdot η \cdot ( {I}_{VCSELb} - {I}_{th} ) \cdot [ 1 - m sin {φ}_{0} ]$$

$${I}_{PDc} = σ \cdot η \cdot ( {I}_{VCSELc} - {I}_{th} ) \cdot [ 1 - m cos {φ}_{0} ]$$

$${I}_{PDd} = σ \cdot η \cdot ( {I}_{VCSELd} - {I}_{th} ) \cdot [ 1 + m sin {φ}_{0} ]$$

This can now be used to extract the I and Q values:

$${I}_{PDa} - {I}_{PDc} = σ \cdot η \cdot ( {I}_{VCSELa} - {I}_{VCSELc} ) + σ \cdot η \cdot ( {I}_{VCSELa} + {I}_{VCSELc} - 2 {I}_{th} ) \cdot m cos {φ}_{0}$$

$${I}_{PDd} - {I}_{PDb} = σ \cdot η \cdot ( {I}_{VCSELd} - {I}_{VCSELb} ) + σ \cdot η \cdot ( {I}_{VCSELd} + {I}_{VCSELb} - 2 {I}_{th} ) \cdot m sin {φ}_{0}$$

$$I = cos {φ}_{0} = \frac{{I}_{PDa} - {I}_{PDc} - σ \cdot η \cdot ( {I}_{VCSELa} - {I}_{VCSELc} )}{σ \cdot η \cdot ( {I}_{VCSELa} + {I}_{VCSELc} - 2 {I}_{th} ) \cdot m}$$

$$Q = sin {φ}_{0} = \frac{{I}_{PDd} - {I}_{PDb} - σ \cdot η \cdot ( {I}_{VCSELd} - {I}_{VCSELb} )}{σ \cdot η \cdot ( {I}_{VCSELd} + {I}_{VCSELb} - 2 {I}_{th} ) \cdot m}$$

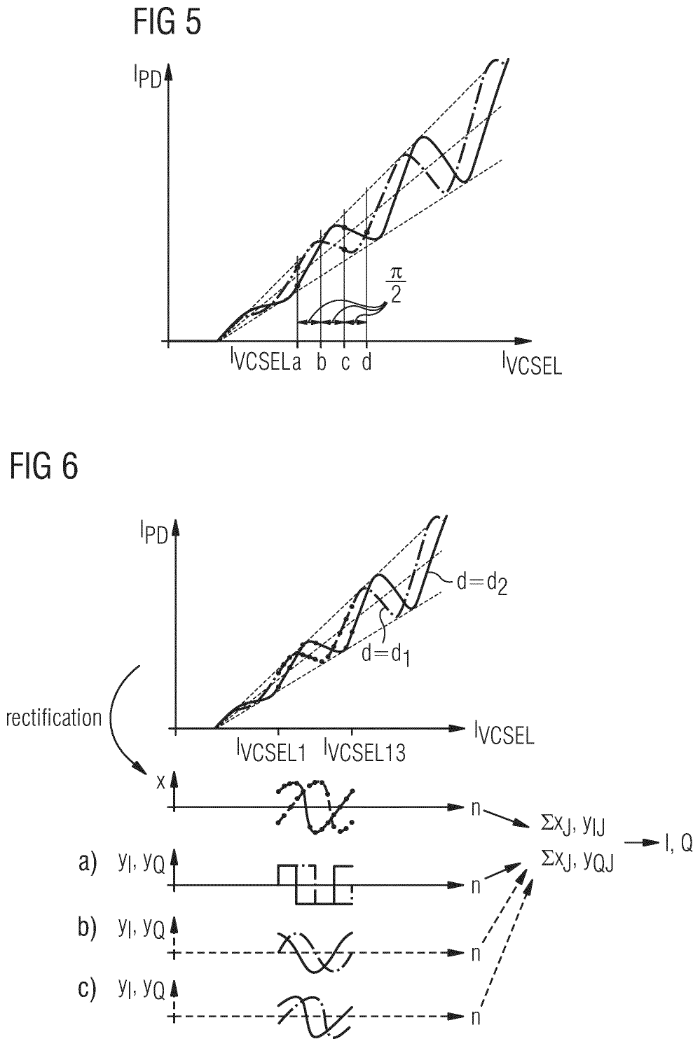

FIG. 6 shows another example detection signal. The depicted graph illustrates a sketch of a response function of a photodiode current I_{PD} (detection signal) to a change in VCSEL driving current I_{VCSEL} (control signal), for two different example target (membrane) positions d of d₁ and d₂. The following illustrates a sweep scan IQ extraction with sinusoidal weighting. The sketch of IQ extraction shows 13 capture points on an I_{VCSEL} sweep, with three example weighting functions.

In this example, the sections of the stimulus waveform may be chosen to yield a wavelength modulation (as a function of I_{VCSEL}) such that the shifted SMI phase can be captured over a 360° range of the SMI phase. Multiple photodiode current I_{PD} (detection signal) values (corresponding to multiple phase values) are captured along the slope of each scan, resulting in time sequences of detection signals, one per each period of the control signal. The sequences can be weighted and summed with a cosine wave to get an I component, and with a sine wave to get a Q component, the SMI phase can be

$${φ}_{FB} = {tan}^{- 1} ( \frac{Q}{I} ) .$$

The drawing illustrates this weighting and summing. The driving current (control signal) I_{VCSEL} is swept (depending on the stimulus waveform) between I_{VCSEL1}, . . . , I_{VCSEL13}, so that 13 photodiode currents I_{PD1}, . . . , I_{PD13} values are captured by the analog-to-digital converter. These are then rectified to remove the non-SMI contribution (DC-component, depicted by the arrow in the drawing) and to scale the SMI contribution (which is proportional to light intensity and thus I_{VCSEL}−dependent), yielding 13 samples xⱼ. These are then multiplied with the correlation functions y₁ and y_{Q}, here sinusoidal/cosinusoidal in graph b) and summed up to give the I and Q components:

$$\sum {x}_{j} \cdot {y}_{{Ij}_{{yields}_{\to }}} I , Q$$

$$\sum {x}_{j} \cdot {y}_{Qj}$$

Sweep scan IQ extraction can also be performed with rectangular weighting. This approach is similar to the IQ extraction with sinusoidal weighting, discussed in detail above, but weighting is done with rectangular factors (constant, only sign changes) instead of cosine/sine weighting, i.e. graph a) in FIG. 6. This simplifies the computation, but comes at a reduced SMI phase result accuracy.

Sweep scan IQ extraction can also be performed with SMI shaped weighting Here weighting involves a precomputed expected SMI response curves instead of cosine/sine weighting, i.e. graph c) in FIG. 6. This is expected to linearize the processing compared to the sinusoidal weighting, i.e. less distortion of the relationship between displacement and computed SMI phase.

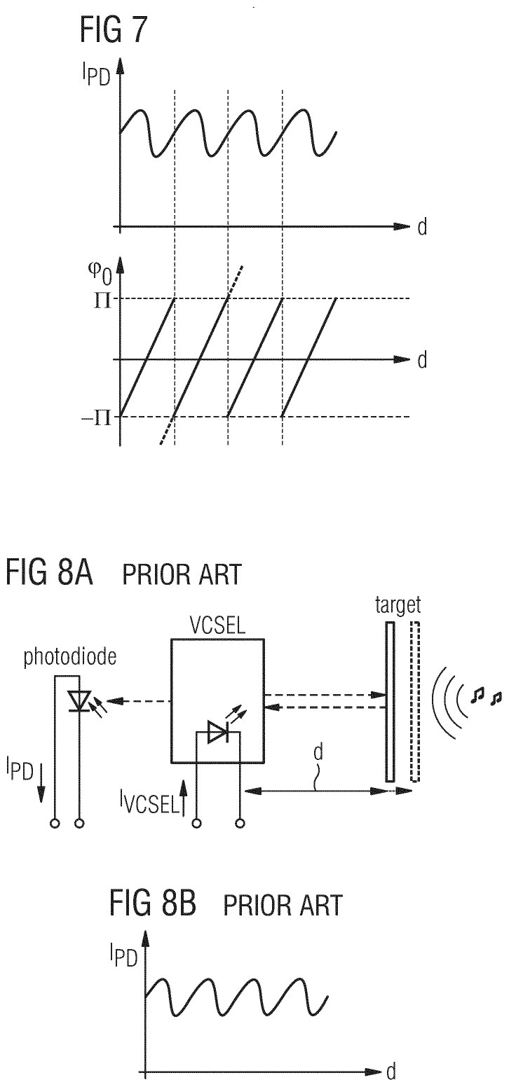

FIG. 7 shows a periodic detection signal as a function of distance and respective stimulus phase φ₀. To extend the range of displacement values that can be processed beyond one SMI phase period, a digital phase unwrapping algorithm removes the phase discontinuity from the periodic phase result, and thus keeps track of the number of entire SMI phase periods that have been walked through by the target movement. This is possible because this readout technique provides target phase values based on multiple SMI phase values around the target's SMI phase for constant I_{VCSEL}, i.e. the target phase can continuously be derived (there is no target position with zero SMI gain or inverted SMI gain). The digital phase unwrapping algorithm is executed in the phase unwrapping unit PUU.

The SMI characteristic is a periodic function with respect to displacement d. The corresponding stimulus phase angle φ₀, which is the result of the target phase computation, is therefore also a periodic function, and varies between ±π (±180°). If the displacement sweeps through such a discontinuity, the displacement d derived from φ₀ would follow, and therefore experiences a significant jump, which is undesired. To avoid this, a phase unwrapping algorithm is processing φ₀, see the block in the drawing.

The algorithm could be implemented to detect such a transition based in the phase result of the preceding sample, φ_{0,n-1}: if the difference to the preceding sample exceeds a threshold value xₜₕ, the current sample's phase is assumed to sit in (have jumped into) the next period, and thus needs to be corrected by an offset of 2π (360°) to eliminate the discontinuity:

$$if ( {φ}_{0 , n} - {φ}_{0 , n - 1} ) > {x}_{th}$$

$$then$$

$${φ}_{0 , n} = {φ}_{0 , n} - 2 π$$

$$if ( {φ}_{0 , n} - {φ}_{0 , n - 1} ) < - {x}_{th}$$

$$then$$

$${φ}_{0 , n} = {φ}_{0 , n} + 2 π$$

This way, the resulting φ₀ would follow the dashed straight line in the drawing, instead of transitioning to the adjacent period, thus, indirectly memorizing the number of periods that have already been walked through before. The xₜₕ would usually be π (180°).

Further options for implementation of the phase shift wave shape and processing of the multiplexed multiple phases can be imagined, and have to be assessed in light of a desired application, e.g. for their feasibility (accuracy, processing complexity, variation robustness). Particularly, a simple on/off I_{VCSEL} pulsing scheme could exploit the slow VCSEL wavelength response, which automatically causes the wavelength to sweep a certain range even without complex I_{VCSEL} current waveform.

While this specification contains many specifics, these should not be construed as limitations on the scope of the present disclosure or of what may be claimed, but rather as descriptions of features specific to particular embodiments of the present disclosure. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

A number of implementations have been described. Nevertheless, various modifications may be made without departing from the spirit and scope of the present disclosure. Accordingly, other implementations are within the scope of the claims.

### REFERENCES

ADC analog-to-digital converter
CLK clock generator
DRV driver circuit
DTC detector
MBN membrane
PUU phase unwrapping unit
SCL semiconductor laser
SGE stimulus generator
SWN switching network
TPC target phase computation unit

What is claimed is:

1. An optoelectronic device for a self-mixing interferometer, comprising:
a driver block operable to provide a time modulated control signal, wherein the control signal has a periodic waveform,
a semiconductor laser (SCL) operable to emit a laser light with a time-dependent characteristics being a function of the control signal and a self-mixing interference optical feedback,
a detector (DTC) operable to generate a detection signal depending on the time-dependent characteristics, and
a switching network (SWN) arranged to provide a time sequence of detection signals per period of the control signal.

2. The optoelectronic device according to claim 1, wherein the optoelectronic device for a self-mixing interferometer comprises a common integrated circuit.

3. The optoelectronic device according to claim 1, wherein
the detector (DTC) comprises;
a photodetector operable to provide the detection signal as an optical power readout, and/or
a voltage meter operable to provide the detection signal as a voltage readout.

4. The optoelectronic device according to claim 1, wherein
the switching network (SWN) is configured to assume a sequence of switching states, and
in each switching state the switching network provides a detection signal from the time sequence of detection signals.

5. The optoelectronic device according to claim 1, wherein the driver block comprises a stimulus generator (SGE) and a driver circuit (DRV), wherein:
the stimulus generator (SGE) is operable to generate a periodic stimulus waveform as a function of time, and
the driver circuit (DRV) is arranged to receive the stimulus waveform and is operable to generate the control signal depending on the received stimulus waveform.

6. The optoelectronic device according to claim 1, further comprising a clock generator (CLK), wherein:
the clock generator (CLK) is operable to provide a clock signal,
the driver circuit (DRV) is operable to provide the time modulated control signal synchronous with the clock signal, and
the sequence of switching states is synchronized with the clock signal.

7. The optoelectronic device according to claim 6, wherein the stimulus generator (SGE) is synchronized with the clock signal so that the time dependence of the stimulus waveform is determined by the clock signal.

8. The optoelectronic device according to claim 1, wherein the driver circuit (DRV) comprises an amplifier operable to generate the time modulated control signal as a driving current for the semiconductor laser (SCL).

9. The optoelectronic device according to claim 1, further comprising an analog-to-digital converter (ADC), wherein
the analog-to-digital converter (ADC) is coupled between the detector and the switching network and operable to receive the detection signal and provide the detection signal in digital form to the switching network, or
the analog-to-digital converter (ADC) is coupled to output terminals of the switching network and comprises time-interleaved ADC-channels, each associated with a corresponding output terminal of the switching network.

10. The optoelectronic device according to claim 1, further comprising a computation unit operable to acquire detection values from the time sequence of detection signals and calculate an output being indicative of a target distance to be placed in a field of view of the semiconductor laser (SCL).

11. The optoelectronic device according to claim 10, wherein
the computation unit comprises a target phase computation unit (TPC) and/or a phase unwrapping unit (PUU),
the target phase computation (TPC) is operable to determine the output from the time sequence of detection signals and corresponding control signal,
the phase unwrapping unit (PUU) is operable to remove a phase discontinuity from the calculated output.

12. A self-mixing interferometer, comprising:
an optoelectronic device according to claim 1, and
a reflective membrane (MBN), placed with respect to the semiconductor laser (SCL) so as to form the self-mixing interferometer.

13. The self-mixing interferometer according to claim 12, wherein the driver block, semiconductor laser (SCL), detector (DTC) and/or switching network (SWN) are integrated into a common integrated circuit.

14. The self-mixing interferometer according to claim 12, arranged as an optical microphone and being operable to provide a sound signal as output.

15. A method for operating a self-mixing interferometer, comprising:
providing a time modulated control signal, wherein the control signal has a periodic waveform,
emitting a laser light towards a target, the laser light having a time-dependent characteristics being a function of the control signal and a self-mixing interference optical feedback,
generating a detection signal indicative of a self-mixing interference depending on laser light reflected back from the target and depending on the time-dependent characteristics, and
providing a time sequence of detection signals per period of the control signal.

16. The method according to claim 15, wherein a distance to the target is calculated from the time sequence of detection signals and the corresponding control signal, and/or the distance is calculated as a function of time to derive a sound signal.
